(19) United States
(12) Patent Application Publication
(10) Pub. No.: US 2025/0236552 A1
(43) Pub. Date: Jul. 24, 2025

(54) OPTICAL ELEMENTS, DEVICES, AND SYSTEMS COMPRISING HALIDE MATERIAL COMPOSITIONS SOLIDIFIED FROM MELTS

(71) Applicant: DSTAR Communications, Inc., Woodland Hills, CA (US)

(72) Inventors: Dmitry Starodubov, Woodland Hills, CA (US); Viktor Dubrovin, Tucson, AZ (US)

(73) Assignee: DSTAR Communications, Inc., Woodland Hills, CA (US)

(21) Appl. No.: 18/959,293

(22) Filed: Nov. 25, 2024

Related U.S. Application Data
(60) Provisional application No. 63/624,633, filed on Jan. 24, 2024.

(51) Int. Cl. C03B 37/014

(52) U.S. Cl. CPC C03B 37/01446; C03B 2201/84

(57) ABSTRACT

Embodiments of the present disclosure are directed to infrared optical lightguides or fibers formed with molten halide material (e.g., silver halide), which can provide low loss broadband transmission of wavelengths from approximately 0.5 microns to approximately 25 microns, and methods for forming such lightguides or other optical devices based on solidifying halide melts. In some embodiments, surfaces of a retaining element may be passivated (e.g., using a silver ion exchange process) before the molten halide material is deposited into the retaining element. In some embodiments, the molten halide material may be solidified in a microgravity environment.

### CROSS-REFERENCE TO RELATED APPLICATIONS

This application claims the benefit of and priority from U.S. Provisional Patent Application Ser. No. 63/624,633, filed Jan. 24, 2024, and entitled, “OPTICAL ELEMENTS, DEVICES, AND SYSTEMS COMPRISING HALIDE MATERIAL COMPOSITIONS SOLIDIFIED FROM MELTS.” The disclosure of the prior application is considered part of and hereby incorporated by reference in its entirety in the disclosure of this application.

### STATEMENT OF GOVERNMENT INTEREST

This invention was made with government support under contract 80NSSC23PB417 awarded by National Aeronautics and Space Administration (NASA). The government has certain rights in the invention.

### TECHNICAL FIELD

This disclosure pertains to enhanced optical material processing, and more specifically to optical elements, devices, and systems (e.g., optical fibers and low-loss infrared planar lightwave circuits) and methods for fabricating the same.

### BACKGROUND

Existing optical lightguides for infrared (IR) light transmission that include chalcogenide, halide, fluoride, and other exotic glass compositions have faced challenges such as high cost, brittleness, environmental susceptibility, and fragility, limiting their widespread practical use.

### BRIEF DESCRIPTION OF THE DRAWINGS

FIG. 1 illustrates an example process for fabricating a lightguide in accordance with embodiments of the present disclosure.

FIGS. 2A-2D illustrate example images of materials produced in accordance with embodiments herein as compared with known techniques.

FIGS. 3A-3B illustrate transmission plots for example lightguides formed in accordance with embodiments herein.

FIG. 3B illustrates performance of a molten-process silver halide sample as compared with an extruded polycrystalline sample.

FIG. 4 illustrates an example planar lightguide fabrication process in accordance with embodiments of the present disclosure.

FIG. 5 illustrates an example process of producing an imaging-capable infrared lightguide bundle with multiple light guiding cores formed in accordance with embodiments herein.

FIG. 6 illustrates an example nonlinear converter that may be formed with embodiments of the present disclosure.

FIG. 7 illustrates an example pigtailed lightwave circuit that may be implemented with embodiments of the present disclosure.

FIG. 8 illustrates an example photonic lightwave circuit that may be implemented with embodiments of the present disclosure.

FIG. 9 illustrates an example master oscillator-power amplifier (MOPA) lightwave circuit that may be implemented with embodiments of the present disclosure.

### DETAILED DESCRIPTION

Embodiments disclosed herein are directed to the fabrication of optical elements, such as optical lightguides or optical fibers, using molten halide materials. The optical elements may provide low loss, broadband transmission of infrared optical signals.

Thermal imaging, optical communications, chemical sensing and medical diagnostics using broadband infrared solutions are rapidly expanding and maturing industries. Readily available optical materials that are transparent in an extended infrared spectral range (e.g., 1-20 microns) are typically environmentally sensitive, structurally unstable, toxic and/or are not mechanically strong. Moreover, the industry-standard processing methods, including Outside Vapor Deposition (OVD), fiber drawing from a preform, and fusion splicing, are not readily available for broadband infrared transmissive devices. Further, material purification methods, component fabrication methods, and scalable manufacturing technologies are not fully developed, therefore limiting the use of such materials and devices.

A molten core fiber approach involves the melting of materials inside fused silica glass tubes, which can be a potential method for creating hybrid optical fibers with a glass cladding and a core with crystalline, metal, or semiconductor composition and a wide variety of doping options. The molten core approach, however, has not been widely used for halide materials. A number of halide glasses and crystals have broadband infrared transmission, which may be ideal for practical applications. However, a typical halide glass, such as fluoride-based ZBLAN (which can include ZrF₄, BaF₂, LaF₃, AlF₃ and NaF), can react with fused silica and decompose at the high temperatures required for the drawing of a fused silica cladding. In addition, ZBLAN elements may be prone to crystallization and react with water, posing manufacturing, environmental stability and safety challenges. Even when ZBLAN fibers are coated with Teflon for protection, crystalline formation occurs at the interface, exacerbating these issues. Moreover, traditional fluoride fiber compositions such as ZBLAN may be unsuitable for use in molten-core fiber fabrication due to their reactivity with silica cladding. For example, such materials may have significant mismatches in the thermal expansion coefficients between the core and cladding materials, leading to delamination of the polycrystalline core from the oxide glass cladding. Additionally, at typical draw temperatures (e.g., those at or above 550° C.), the halide core develops bubbles at the core-cladding interface, further complicating the process.

Non-fluoride halide materials, such as chlorides and bromides, can offer an improved transmission at longer infrared wavelengths while also being less chemically aggressive. Silver chloride and silver bromide polycrystalline fibers are not very toxic, commercially available, and multimode polycrystalline infrared (PIR) fibers, made from AgCl₍₁₋ₓ₎Brₓ silver halides, serve as the primary broadband infrared solution, covering the spectral range from approximately 3-17 microns. It has been reported that reducing the rod diameter increases scattering in single crystals of AgClBr and extruded optical fibers. This loss has been attributed to pores with an average radius of 0.4-0.6 microns, consistent with theoretical models of cation vacancies localized at charged dislocations.

Silver halide crystals are typically produced from a molten composition in a fused silica glass or borosilicate glass container. However, silver halide has been problematic for use in molten core fabrication techniques, as the formation of bubbles at the interface of the container may occur with silver halide melts, requiring the removal of the outer crystal layer at the end of the process. Furthermore, currently available fabrication methods for silver halide fibers suffer from excessive scattering loss due to crystal formation and non-uniformity of the core-cladding interface.

The present disclosure overcomes these or other issues and provides a molten core technology platform for optical elements formed using halide materials with broadband transmission. The optical elements of the present disclosure may be fabricated by melting polycrystalline optical fibers with established material purity, and then slowly cooling the melt without formation of the crystal phase. The halide material may be silver halide (AgCl₍₁₋ₓ₎Brₓ, e.g., where x is between approximately 0.4-0.8, e.g., AgCl_{0.25}Br_{0.75} or AgCl_{0.5}Br_{0.5}) in certain embodiments, or may be another type of halide material, such as, for example, CsI, CsBr, TlBr, TlCl, and KCl, as described in “Infrared Fiber Optics” by P. Klicek and G. Sigel, 1989, and incorporated herein by reference. Optical elements fabricated according to the present disclosure may allow for low loss broadband infrared transmission, e.g., from approximately 0.5 microns to approximately 25 microns.

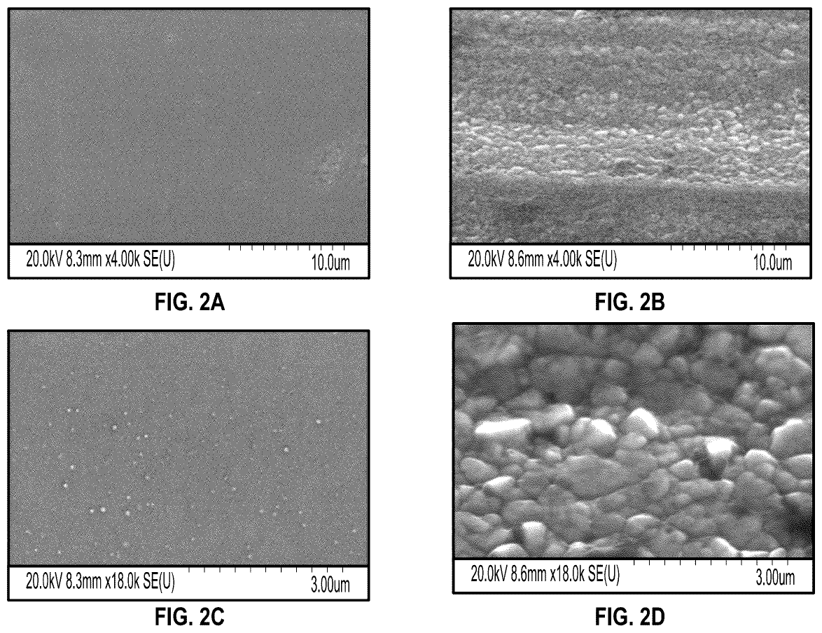

In particular, embodiments herein may provide lightguides and optical fibers that are fabricated using a molten silver halide material, with the resultant lightguide/fiber core having a substantially isotropic composition (as shown, for example, in FIGS. 2A, 2C) as opposed to the non-isotropic composition of current polycrystalline halide cores that have substantial grain size and visible grain boundaries under microscope (as shown, for example, in FIGS. 2B, 2D). A substantially isotropic composition, as used herein, may refer to the solidified halide composition not having microscopic features that are comparable in size with the operating wavelength of an optical element (e.g., does not have grains larger than 0.5-1 um) and/or the processing wavelength for fabrication of light-induced modifications of the material. Because of the substantially isotropic composition of the solidified molten halide material, optical elements produced by embodiments herein do not exhibit nearly as much scattering as conventional halide core optical elements.

An alkaline glass cladding with a glass transition temperature that is comparable with a melting temperature or a glass transition temperature of a halide core material may be used. For instance, in some embodiments, soda-lime glass may be used as a cladding or lightguide substrate material. Another type of glass may be used in other embodiments, e.g., borosilicate glass. A contacting surface of the glass cladding/substrate may be treated with an ion exchange process that suppresses the reaction of the cladding with the halide melt. For example, ion exchange in a salt melt containing silver nitrate may be used for treating the contacting surface of the glass. Halide melts that include silver bromide and/or silver chloride may solidify into transparent glass-like elements with reduced scattering in the passivated containment. In some embodiments, the glass may be etched with an argon plasma or with hydrofluoric acid to modify the glass surface prior to exposure with the halide melt. Optical fibers can thus be fabricated using a passivated outer cladding and a molten halide core via a fiber drawing process.

The halide lightguides/cores produced by aspects of the present disclosure may exhibit a substantially isotropic structure with reduced crystalline scattering at shorter wavelengths. Differential calorimetry measurements of some samples may indicate that the substantially isotropic halide core material does not remain in a glassy state, e.g., may not exhibit glass transition at a glass transition temperature. In addition, optical waveguides (also referred to as lightguides) with halide cores fabricated according to the present disclosure may demonstrate their potential for fully utilizing infrared transmission of wavelengths from approximately 0.5 microns to greater than 25 microns. In some instances, certain processing optimizations, e.g., ground-based or microgravity-based purification processes, along with material optimization (e.g., doping of the silver halide with rare earth ions, such as Er, Ho, Cr, Ce, Tm, Yb, or Nd to modify the photosensitivity), can allow for ultra-low insertion loss infrared lightguides.

In some embodiments, a tapered halide core fiber may be used for generation of broadband supercontinuum. Further, a lightguide/array can be fabricated by filling a passivated glass capillary (or capillary array) with a molten halide melt without melting the glass capillaries or having other adverse reactions. Such a lightguide array with a plurality of optical elements can be used for imaging applications, such as endoscopy.

In some embodiments, selective etching in an ammonium bifluoride solution may be implemented to selectively remove a glass support substrate without dissolving the halide light guiding elements formed on the support substrate. The exposed light guiding halide elements can subsequently be bonded onto a final substrate to form an infrared light guiding circuit. The infrared light guiding circuit can be used to combine the light from multiple quantum cascade laser emitters using spectral, spatial, coherent combining and wavelength locking. The halide host material may be doped with active ions, such as, for example, Er, Ho, Cr, Ce, Tm, Yb, or Nd and/or other dopant elements known in the art, to achieve optical amplification and other desired optical properties, including but not limited to polarization rotation and nonlinear conversion.

In some embodiments, microgravity processing can be implemented to purify the halide materials, which can further reduce insertion loss of the resultant fiber/lightguide by suppressing crystallization and phase separation. In addition, microgravity processing may increase the doping concentrations of active ions in the halide host material.

In some embodiments, Fiber Bragg gratings can be formed in the halide material for implementation of lasers, including laser cavities and externally locked lasers. In some embodiments, high intensity violet or ultraviolet (UV) laser exposure of a Cerium doped silver halide material can be used to precipitate silver and form infrared optical polarizers.

In some embodiments, molten halide material can be used as a medium for optically coupling of infrared lightguides and infrared optical fibers. In some embodiments, a lightwave circuit can include a lightguide fabricated using molten halide material. The lightguide and/or lightwave circuit may be included in, for example, a laser, a Lidar device, or a master oscillator-power amplifier (MOPA).

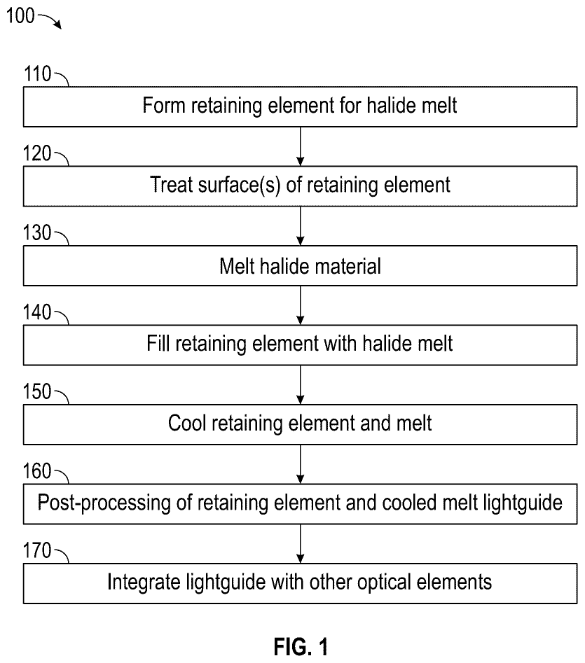

FIG. 1 illustrates an example process 100 for fabricating a lightguide in accordance with embodiments of the present disclosure. Although particular operations are shown in FIG. 1, the process 100 may include additional, fewer, or other operations than those shown. In addition, although shown as separate operations in FIG. 1, certain of the operations (or portions thereof) may be performed simultaneously. In embodiments herein, lightguides may have diameters or cross-sectional measurements of less than 100 um, which may be useful for broadband infrared transmission.

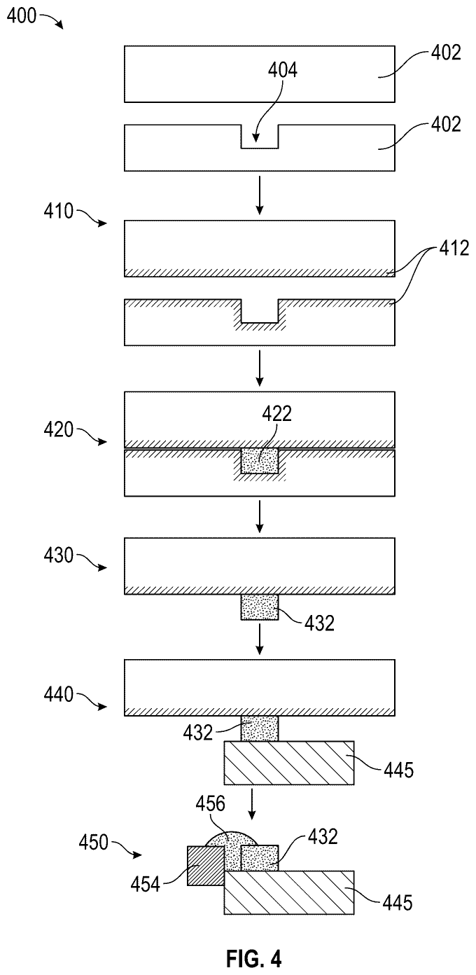

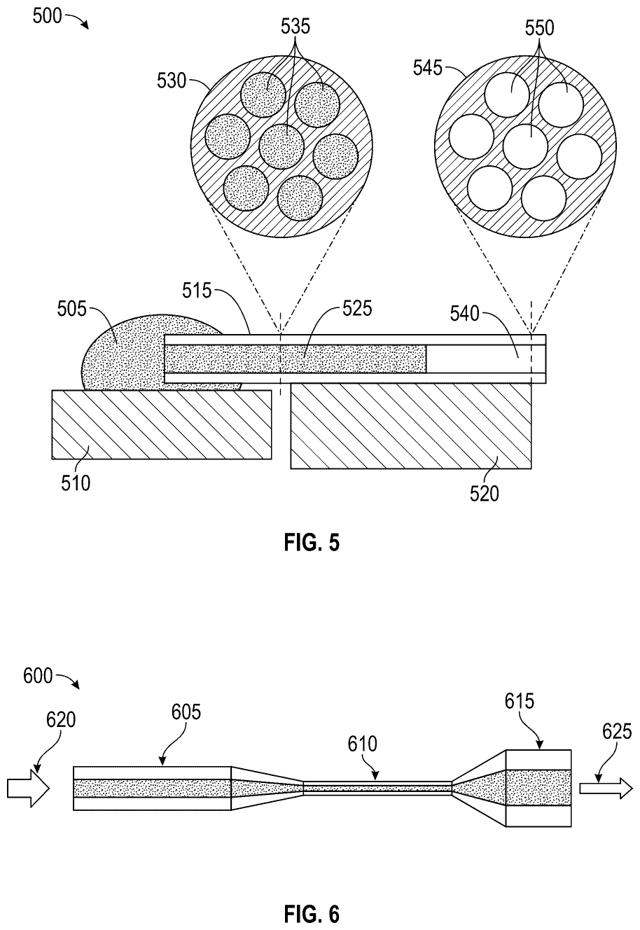

At 110, a retaining element for receiving or maintaining a halide melt is formed. In some embodiments, the retaining element may be a glass substrate for forming a planar lightguide, while in other embodiments, the retaining element may be a glass cladding material for forming an optical fiber. Creation of the retaining element may include, for example, creating a groove (or other type of pattern) in the planar glass substrate (e.g., 404 in the substrate 402 of FIG. 4) for implementation of a planar optical waveguide structure or fabrication of a tapered capillary (e.g., like the one shown in FIG. 5) for creation of a tapered optical fiber waveguide (e.g., 600 of FIG. 6).

At 120, one or more surfaces of the retaining element are treated. This may include passivating the surfaces that are to be in contact with the halide melt material. The passivation may include an ion exchange process. For example, a soda lime glass retaining element or substrate may be passivated for use in forming a silver halide melt-based lightguide (e.g., as described below with respect to FIG. 4). The ion exchange process may implement a silver ion exchange, which may enhance wetting properties with the halide melt to be used. The ion exchange may be performed at a temperature between approximately 220 C-400° C. at a duration between approximately 2 minutes-6 hours. After the completion of the ion exchange process, the retaining element may be cooled down, rinsed in water, and then dehydrated using alcohol. Surface passivation may be useful to avoid the typical interaction issues seen between glass and molten halide materials (e.g., bubble formation); however, such issues may not be present with other types of substrate materials and accordingly, surface passivation may not be needed.

At 130, a halide material is melted (e.g., in a low moisture and low oxygen environment) until molten, and at 140, the molten halide material is flowed or otherwise dispensed into the treated retaining element. The molten halide material may be placed into contact with and cover the ion exchanged surface of the retaining element by a wetting/wicking effect, which may allow for a good surface quality for the lightguide and may completely fill any preformed capillaries and grooves with small cross-sections using surface tension and capillary action. In some embodiments, a capillary action may be used to dispense the molten halide material or otherwise fill the retaining element. Such a process has the benefit of dispensing a high-quality molten halide material while leaving any potential material contaminants at the area of melting, potentially minimizing the presence of contaminants in the formed lightguide.

At 150, the melt-filled retaining element is cooled, e.g., by setting it into a cooling configuration. For example, where a glass capillary tube is used as the retaining element, the glass capillary may be drawn and cooled down to form a molten core fiber. In another embodiment, supporting substrates may be aligned and placed against one another, setting the interface protections for the molten halide material therebetween and protecting its surfaces for the subsequent cooling that occurs (which results in solidification of the halide material to become the resultant lightguide).

At 160, post-processing of the retaining element support and/or lightguide may be performed. This can include etching away a glass retaining element or other material or annealing the halide lightguide to reduce insertion loss. In some embodiments, the halide lightguide may be coated with a suitable cladding material using techniques known to those skilled in the art. In other embodiments, post-processing can include annealing of the halide fiber core to minimize its scattering loss after drawing. In some embodiments, the lightguide may be also bonded to a new substrate that is different from the initial retaining element, e.g., a material or element with broadband infrared transmission as opposed to a supporting element comprising soda lime glass.

At 170, the formed lightguide can be integrated into a multi-functional lightwave circuit, which may include additional optical components, e.g., light sources, detectors, isolators, circulators, modulators, nonlinear converters, Bragg reflectors and/or polarizers to achieve the desired functionality of the final assembly. In some embodiments, a halide melt solidified between two planar glass substrates may result in a planar layer of halide material. The halide material can be separated from at least one of the glass substrates mechanically or by etching away the glass. The use of a glass substrate with a grove pattern can provide a ridge waveguide structure after filling the groves with the halide melt and etching away the glass substrate. Subsequently bonding the waveguide structure onto mechanically stable and low-loss material for support may enable infrared photonic lightguide circuits for various applications. Example circuits are described further below.

In certain embodiments, the halide melt material may be doped with elements that provide additional functionalities to lightguides, such as optical amplification and photosensitivity. In some embodiments, the solidification of the halide melt may be performed in a microgravity environment, which may improve the quality of light guiding material and increase a concentration of functional dopants. In some embodiments, a glass cladding tube may be used as the retaining element to fabricate molten core optical fibers with halide cores.

FIGS. 2A-2D illustrate example images of materials produced in accordance with embodiments herein as compared with known techniques. In particular, these figures illustrate SEM images of a first AgCl/Br sample fabricated in accordance with embodiments herein, i.e., solidifying a halide melt, against a second AgCl/Br sample that is commercially available and produced by an extrusion process of polycrystalline AgCl/Br. FIG. 2A illustrates the first sample under ×4,000 magnification, FIG. 2B illustrates the second AgCl/Br sample under ×4,000 magnification, FIG. 2C illustrates the first sample under ×18,000 magnification, and FIG. 2D illustrates the second sample under ×18,000 magnification. As will be seen, embodiments herein may provide lightguides having a substantially isotropic composition as shown in FIGS. 2A, 2C, as opposed to the non-isotropic composition of current polycrystalline halide lightguides that have substantial grain boundaries as shown in FIGS. 2B, 2D.

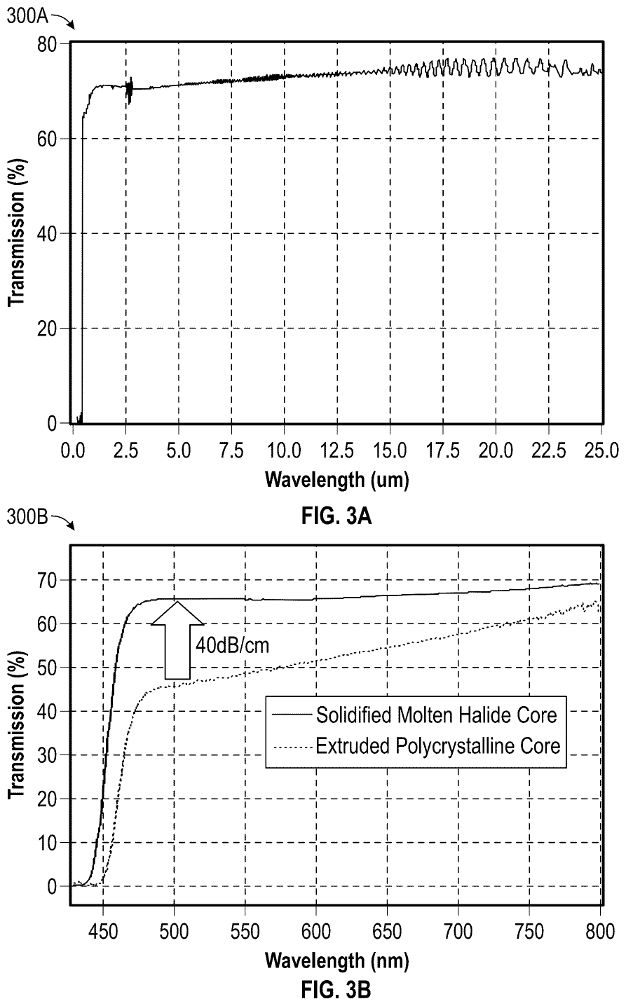

FIGS. 3A-3B illustrate transmission plots 300A, 300B for example lightguides formed in accordance with embodiments herein. As shown in FIG. 3A, silver halide lightguide samples produced in accordance with embodiments herein may offer broadband transmission from approximately 0.5 microns to over 25 microns. FIG. 3B illustrates performance of a molten-process silver halide sample as compared with an extruded polycrystalline sample. As shown, a solidified molten halide core can provide an approximately 40 dB/cm increase in transmission around wavelengths of approximately 500 nm as compared with an extruded polycrystalline core. This may be due to suppression of pores and polycrystalline grain boundaries in the solidified molten core, which can noticeably reduce scattering and improve optical transmission over the extruded polycrystalline core, especially at shorter wavelengths as shown.

FIG. 4 illustrates an example planar lightguide fabrication process 400 in accordance with embodiments of the present disclosure. Although particular operations are shown in FIG. 4, the process 400 may include additional, fewer, or other operations. At the beginning of process 400, two planar glass substrates 402 are provided as a retaining element, which may serve as a mold for receiving and solidifying a halide material melt as described herein. The substrates 402 may include one or more groves 404 formed therein. The grooves 404 may have any suitable pattern, as needed for a particular circuit or application. The grooves 404 provide a guide for the molten halide material melt to flow, thereby forming a lightguide pattern according to the groove pattern.

Prior to flowing the halide melt, at 410, an ion exchange process is performed on the surfaces of the glass substrates 402. The ion exchange process may be as described above, and may produce passivated surface layers 412 on each of the substrates 402 as shown. Then, at 420, the grooves 404 are filled with the halide material melt to form a lightguide 422. This may include sandwiching the glass substrates 402 together as shown. In some embodiments, a capillary action may be used to flow the molten halide material into the grooves 404, which can minimize defects in the resultant lightguide 422.

At 430, one of the substrates 402 is removed; however, in some embodiments, both substrates 402 may be removed. The substrates 402 may be removed either mechanically (e.g., by polishing or grinding), chemically (e.g., by etching), or by a combination thereof. In one embodiment, for example, a glass support substrate 402 may be etched away in a 9% solution of ammonium bifluoride. Removal of one of the substrates 402 yields an exposed lightguide 432, which can then be coated by a suitable cladding layer.

At 440, the lightguide 432 is coupled (e.g., bonded) to a support substrate 445, which may comprise a material different from glass. In some embodiments, for example, the substrate 445 is formed of a material with a lower refractive index than that of the lightguide 432, with low infrared absorption, and a close coefficient of thermal expansion.

At 450, a lightwave circuit is assembled by integrating the lightguide 432 and substrate 445 with other optical elements. For instance, in the example shown, another optical element 454 (e.g., a light transmitter or/and receiver) is coupled to the lightguide 432 via an optical coupling material 456, which, in some embodiments, may comprise a solidified halide melt (e.g., to minimize coupling loss). For example, in some embodiments, a coupling material can be added to the coupling area at high temperatures (e.g., close to the melting temperature of the coupling material) to establish plasticity and then set in place by pressing the lightguide 432 and the element 454 toward each other with the coupling material between. In other embodiments, a molten halide material may be used as the coupling material and placed in the gap between the lightguide 432 and the element 454 and then cooled/solidified. In some embodiments, the molten halide material may be illuminated with a selectively absorbing light to facilitate coupling, without melting either the lightguide 432 or optical element 454. The lightguide 432 may be integrated in other ways and/or with other optical elements than those shown.

FIG. 5 illustrates an example process 500 of producing an imaging-capable infrared lightguide bundle with multiple light guiding cores 535 formed in accordance with embodiments herein. In the example shown, the light guiding cores 535 are formed from a molten halide material 505 that is disposed on a first heating element 510 and then placed in a working proximity with a capillary array 515 disposed on a second heating element 520. The capillary array 515 may be a glass cladding material for use as an optical fiber, and the inside surfaces of the openings of the capillary array 515 may be passivated as described above (e.g., using an ion exchange process). The molten halide material 505 is wicked, by capillary action, into capillary openings of the capillary array 515 over at least a portion 525 of the array (as shown in the cross section 530), while a remaining portion 540 of the array may be left with unfilled capillaries 550 (as shown in the cross section 545) or may be filled. In an embodiment, the heating elements 510 and 520 are set to temperature in a range of approximately 425° C.-550° C., which can allow the silver halide material 505 to melt. While the previous description is with regard to capillary filling action of an array, e.g., to crate a lightguide bundle or fiber, the same concepts may be applied to filling grooves in a substrate (e.g., the groove 404 described above).

FIG. 6 illustrates an example nonlinear converter 600 that may be formed with embodiments of the present disclosure. The example converter 600 includes an input fiber section 605, a tapered-down section 610 and an output fiber section 615. Each of the sections of the converter 600 include a halide core solidified from a molten process as described above. In operation, an input light signal 620, such as picosecond or femtosecond laser pulse, may be converted into a supercontinuum output 625 spanning from approximately 1 micron to approximately 15 microns in wavelength. The tapered-down section 610 may have a diameter optimized to achieve the spectral uniformity of the output 625. In one embodiment, the input core diameter in the example shown may be approximately 9 microns, and the core diameter of the tapered region may be approximately 6 microns.

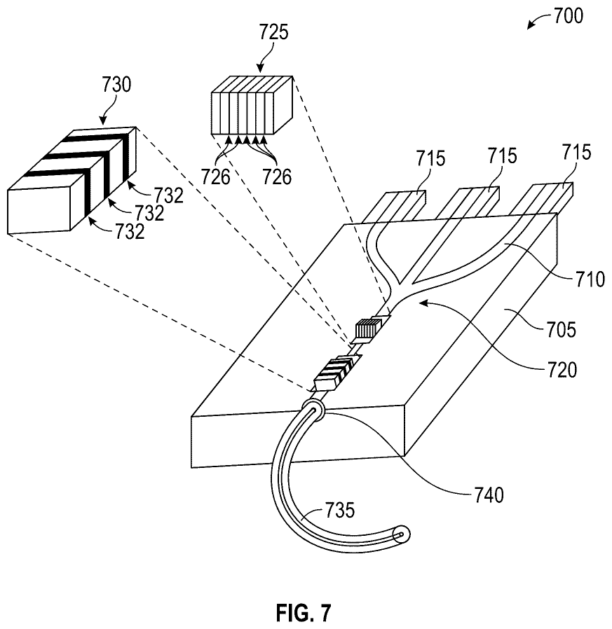

FIG. 7 illustrates an example pigtailed lightwave circuit 700 that may be implemented with embodiments of the present disclosure. The pigtailed lightwave circuit 700 comprises a substrate 705 with a lightguide pattern 710 thereon. The lightguide pattern 710 may be formed with a molten halide material using the process described above. In one embodiment, the lightwave circuit 700 combines the optical outputs of several light source elements 715 into a single output fiber. In another embodiment, the elements 715 are optical signal receivers and the lightwave circuit is configured as a splitter. The light paths of transmitter and/or receiver elements 715 are optically combined or split using a combiner/splitter 720. The circuit 700 also includes a polarizer 725 and Bragg grating 730 that are each integrated in the lightguide pattern 710.

In certain embodiments, the lightguide pattern is formed using a silver halide material (which may be co-doped, e.g., with Ce, Er, Ho, and/or Cr), and the integrated polarizer 725 may be formed inside the lightguide by focused UV light (e.g., approximately 400 nm wavelength) exposure of the silver halide material. For example, the polarizer 725 is formed by delineating layers of precipitated metallic silver 726 along a propagation direction of the lightguide. The Bragg grating 730 is configured as a spectrally selective filter in reflection and/or transmission, and includes refractive index variations along the lightguide and transversely to its propagation direction. Similar to the polarizer 725, the Bragg grating 730 may be formed by focused UV light exposure of the co-doped silver halide material of the lightguide, forming layers of precipitated metallic silver 732 along the length. The UV light exposure described above may precipitate nano-scale silver structures in the host halide material. The UV light exposure may cause quantum dots to be formed in the host material. Some embodiments may utilize a UV laser system with hybrid output that combines the light of a blue/UV laser and the light of infrared fiber laser into a single beam, which could be used for light exposure of the host material for other processing of materials. The circuit 700 may include other optical elements formed using similar concepts.

The circuit 700 further includes an output fiber 735 that is optically coupled to the lightguide pattern 710. In some embodiments, the output fiber 735 is coupled to the lightguide pattern 710 via a region 740 of solidified halide melt, e.g., as described above.

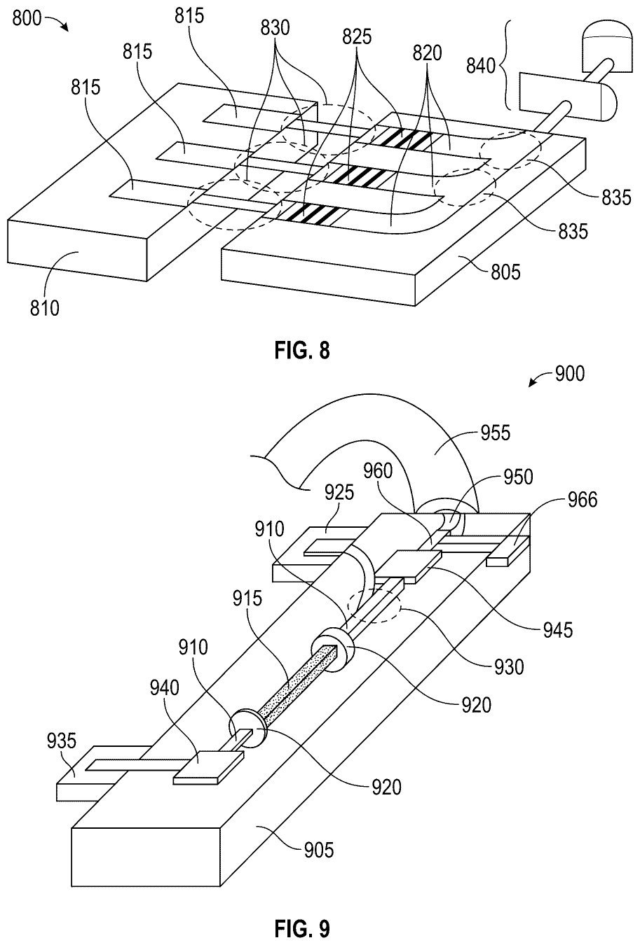

FIG. 8 illustrates an example photonic lightwave circuit 800 that may be implemented with embodiments of the present disclosure. The photonic lightwave circuit 800 includes a light source with a beam combined quantum cascade laser array and a high-brightness output. More particularly, the photonic lightwave circuit 800 is formed in a substrate 805 and positioned in a working proximity to a quantum cascade laser array 810 with emitters 815. The substrate 805 includes lightguides 820 at spacings matching those of the emitters 815 to capture light emitted by them. The lightguides 820 may be formed from a solidified halide melt in accordance with embodiments of the present disclosure. The circuit 800 includes grating elements 825 that provide optical feedback to the emitters 815 in order to lock their wavelength. In certain embodiments, the grating elements 825 are integrated with the solidified halide lightguides 820 and formed using UV light exposure process described above.

The circuit 800 includes coupling elements 830 to couple the emitters 815 to the lightguides 820. In certain embodiments, the coupling elements 830 are formed using a solidified halide melt as described above to minimize coupling losses. The circuit 800 further includes coupling elements 835 that combine signals from each of the lightguides 820 into a single output that is provided to an output coupling element 840. The output coupling element 840 may be any suitable output, and may be based on a desired output of the circuit 800. In the example shown, the output coupling element 840 is an optical telescope that creates a collimated output beam, which may be provided to one or more additional optical elements not shown. In another embodiment, the output coupling element 840 may be an output optical fiber.

FIG. 9 illustrates an example master oscillator-power amplifier (MOPA) lightwave circuit 900 that may be implemented with embodiments of the present disclosure. The lightwave circuit 900 includes a substrate 905 with lightguide sections 910 coupled to an amplifying doped lightguide section 915 via coupling regions 920. In certain embodiments, the lightguide sections 910, 915, and coupling regions 920 may be formed from solidified halide materials as described herein.

The circuit 900 further includes a pump 925 that is coupled to a lightguide section 910 using a coupler 930 as shown, and an oscillator 935 that is coupled to another lightguide section 910 through an optical element 940 as shown. The optical element 940 may be an optical isolator in certain embodiments. The circuit 900 further includes an element 945 toward the output of the amplifying lightguide section 915. The element 945 may also be an optical isolator in certain embodiments. The circuit 900 further includes an output taper portion 950, which may be oriented at a non-orthogonal angle with respect to the output endface of the substrate 905 as shown. This may aid in reducing back reflection of the light signals. The circuit 900 further includes an output fiber 955 that collects light signals from the taper portion 950. The circuit 900 further includes a tap coupler 960, which may be included to guide a small amount of the optical output signals to a monitoring receiver 966 as shown.

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Embodiments of the present disclosure may be implemented in many other ways beyond those described above. For example, a nonlinear converter may include an optical fiber with a solidified halide material core, where the fiber core has an initial diameter of approximately 9 microns tapered gradually down to a diameter of approximately 6 microns or less for a section of approximately 30 cm. A femtosecond laser with approximately 1 micron wavelength can accordingly be converted to a supercontinuum output with a wavelength span from approximately 1 micron to 16 microns, which may be enabled by the low loss broadband characteristics of solidified halide melt core fibers produced by embodiments of the present disclosure.

As another example, an imaging or sensing optical fiber bundle may be implemented with a solidified halide material core. The imaging/sensing fiber bundle may include an optical fiber with an outer cladding diameter in the range of approximately 100 microns to 1.2 mm, with multiple cores having diameters in the range of approximately 6 microns to 110 microns and providing more than a 50% fill factor of the cross section. The several lightguides may be terminated using precipitated silver absorption and used as a thermal background reference. Bragg gratings may be formed in some of the lightguides to serve as strain and/or temperature sensors.

As yet another example, an infrared polarizer may be implemented with a solidified halide material. For instance, the polarizer may include a focused light from a diode laser with a wavelength of approximately 405 nm operating in a single transverse mode may be used. The composition of halide material of the present disclosure may include AgCl, AgBr and/or AgI. The properties of the bulk halide material of the present disclosure may be similar to glass compositions described in the art (e.g., ZBLAN-based glass). However, the solidified halide materials of the present disclosure may provide better transmission in the longer infrared wavelengths as compared to the glass compositions in the art, which may make it possible to use as polarizer for longer wavelengths. The halide material of the present disclosure may be co-doped with Cerium or other materials in certain embodiments. As previously described, UV light exposure of the material of the present disclosure may produce precipitated silver patterns inside the material. The optical exposure of the material may create elongated silver inclusions that exhibit dichroism. The elongation of the optical components of the present disclosure in combination with annealing after the laser exposure may be used to optimize the dichroic ratio of the polarizer for the desired infrared wavelength. Similar laser exposure of lower intensity and thermal post-treatment with suppressed silver precipitation is used for Bragg grating formation in the material of the present disclosure.

Other example embodiments are listed below. It will be understood that any of the following examples may include any one or more of, and any combination of, the other examples described below.

Example P1 is a lightguide for broadband transmission, comprising: a halide material composition solidified from a melt.

Example P2 includes the lightguide of Example 1, wherein the halide material composition is solidified in a microgravity environment.

Example P3 includes the lightguide of Example 1 or 2, the lightguide formed using a soda-lime glass support with an ion-exchange treated surface.

Example P4 includes the lightguide of Example 3, where the soda-lime glass support is removed using etching.

Example P5 includes the lightguide of any preceding Example, wherein the halide material composition includes silver chloride and/or silver bromide.

Example P6 includes the lightguide of any preceding Example, wherein the halide material composition includes active element doping selected from a group comprising at least one of Ce, Er, Ho, Dy, Mn, Fe, or Cr.

Example P7 includes the lightguide of any preceding Example, wherein the lightguide is an optical fiber or a planar waveguide.

Example P8 includes the lightguide of any preceding Example, further comprising a precipitated absorptive structure for polarization control.

Example P9 includes the lightguide of any preceding Example, further comprising a Bragg grating.

Example P10 includes the lightguide of any preceding Example, wherein the lightguide is a nonlinear converter.

Example P11 is a master oscillator-power amplifier (MOPA) comprising a photonic lightwave circuit, the photonic lightwave circuit comprising a lightguide according to any of Examples 1-10.

Example P12 is a Lidar apparatus comprising a photonic lightwave circuit, the photonic lightwave circuit comprising a lightguide according to any of Examples 1-10.

Example P13 is a photonic lightwave circuit with external cavity locked quantum cascade lasers, the photonic lightwave circuit comprising a lightguide according to any of Examples 1-10.

Example P14 is a photonic lightwave circuit that has coherently combined light sources, the photonic lightwave circuit comprising a lightguide according to any of Examples 1-10.

Example P15 is a photonic lightwave circuit that has tunable wavelength element, the photonic lightwave circuit comprising a lightguide according to any of Examples 1-10.

Example P16 is a laser comprising a lightguide according to any of Examples 1-10.

Example P17 is an imaging bundle comprising a lightguide according to any of Examples 1-10.

Example P18 is an apparatus or system comprising a lightguide according to any of Examples 1-10.

Example P19 is an optical system, comprising an optical lightguide that is produced by solidifying a halide optical melt.

Example P20 includes the optical system of Example 19, wherein the system is a sensor system.

Example P21 includes the optical system of Example 19, wherein the system is a medical diagnostics system.

Example P22 includes the optical system of Example 19, wherein the system is a catheter and the lightguide is in the catheter.

Example P23 includes the optical system of Example 19, wherein the system is an endoscope.

Example X1 is an apparatus or system comprising an optical lightguide or optical fiber formed from a halide (e.g., silver halide (AgCl₍₁₋ₓ₎Brₓ)) melt as disclosed herein.

Example X2 is a method of fabricating an optical lightguide or optical fiber from a halide (e.g., silver halide) melt as disclosed herein.

Example X3 is an apparatus produced by the method of Example X2.

Example 1 is an apparatus comprising: an optical circuit comprising a lightguide, the lightguide comprising a substantially isotropic halide material composition.

Example 2 includes the apparatus of Example 1, wherein the halide material composition does not include grains larger than 0.5 um.

Example 3 includes the apparatus of Example 1 or 2, wherein the halide material composition is a solidified molten silver halide material.

Example 4 includes the apparatus of any one of Examples 1-3, wherein the halide material composition includes Silver (Ag) and at least one of Chlorine (Cl), Bromine (Br), and Iodine (I).

Example 5 includes the apparatus of Example 4, wherein the halide material composition includes AgCl₍₁₋ₓ₎Brₓ, e.g., where x is between approximately 0.4-0.8.

Example 6 includes the apparatus of any one of Examples 1-5, wherein the halide material composition includes dopants, the dopants including at least one of Cerium (Ce), Erbium (Er), Holmium (Ho), Dysprosium (Dy), Manganese (Mn), Iron (Fe), Chromium (Cr), Thulium (Tm), Ytterbium (Yb), or Neodymium (Nd).

Example 7 includes the apparatus of any one of Examples 1-6, wherein the halide material composition has an optical transmission of greater than 60% for wavelengths between approximately 0.5 um and 25 um.

Example 8 includes the apparatus of any one of Examples 1-7, wherein the lightguide is an optical fiber or a planar optical waveguide.

Example 9 includes the apparatus of any one of Examples 1-8, further comprising a precipitated absorptive structure for polarization control.

Example 10 includes the apparatus of any one of Examples 1-9, further comprising a Bragg grating.

Example 11 includes the apparatus of any one of Examples 1-10, wherein the lightguide is a nonlinear converter.

Example 12 includes the apparatus of any one of Examples 1-11, wherein the lightguide has a diameter of less than 100 um.

Example 13 is a method of forming a lightguide, comprising: passivating a surface of a glass retaining element; depositing a molten halide material onto the passivated surface of the glass retaining element; and cooling the glass retaining element and the molten halide material to solidify the halide material.

Example 14 includes the method of Example 13, further comprising heating the halide material to a temperature between approximately 425° C.-550° C.

Example 15 includes the method of Example 13 or 14, wherein passivating the surface of the glass retaining element comprises performing a silver ion exchange process.

Example 16 includes the method of Example 15, wherein the silver ion exchange process comprises exposing the surface to a salt melt comprising silver nitrate.

Example 17 includes the method of Example 15 or 16, wherein the silver ion exchange process is performed at a temperature between approximately 425° C.-550° C.

Example 18 includes the method of any one of Examples 13-17, wherein the glass retaining element is a glass substrate defining at least one groove, inner surfaces of the groove are passivated, and the molten halide material is deposited into the groove.

Example 19 includes the method of any one of Examples 13-18, wherein the glass retaining element is an optical fiber cladding defining at least one opening therein, inner surfaces of the opening are passivated, and the molten halide material is deposited into the at least one opening.

Example 20 includes the method of any one of Examples 13-19, wherein the glass retaining element comprises soda-lime glass or borosilicate glass.

Example 21 includes the method of any one of Examples 13-20, further comprising removing the glass retaining element by etching.

Example 22 includes the method of any one of Examples 13-21, wherein the molten halide material is a silver halide.

Example 23 includes the method of Example 22, wherein the molten halide material includes AgCl₍₁₋ₓ₎Brₓ, e.g., where x is between approximately 0.4-0.8.

Example 24 includes the method of Example 22 or 23, wherein the molten halide material includes dopants, the dopants including at least one of Cerium (Ce), Erbium (Er), Holmium (Ho), Dysprosium (Dy), Manganese (Mn), Iron (Fe), Chromium (Cr), Thulium (Tm), Ytterbium (Yb), or Neodymium (Nd).

Example 25 includes the method of any one of Examples 13-24, wherein the halide material is deposited onto the passivated surface via capillary action.

Example 26 includes the method of any one of Examples 13-25, wherein the halide material is solidified in a microgravity environment.

Example 27 is a lightguide formed by the method of Examples 13-26.

Example 28 includes the lightguide of Example 27, wherein the lightguide has an optical transmission of greater than 60% for wavelengths between approximately 0.5 um and 25 um.

Example 29 includes the lightguide of Example 27 or 28, wherein the lightguide is an optical fiber or a planar optical waveguide.

Example 30 includes the lightguide of any one of Examples 27-29, further comprising a precipitated absorptive structure for polarization control.

Example 31 includes the lightguide of any one of Examples 27-30, further comprising a Bragg grating.

Example 32 includes the lightguide of any one of Examples 27-31, wherein the lightguide is a nonlinear converter.

Various aspects have been described above using terms commonly employed by those skilled in the art to convey the substance of their work to others skilled in the art. However, it will be apparent to those skilled in the art that the present disclosure may be practiced with only some of the described aspects. For purposes of explanation, specific numbers, materials, and configurations have been set forth to provide a thorough understanding of the illustrative embodiments. However, it will be apparent to one skilled in the art that aspects of the present disclosure may be practiced without all of the specific details. In addition, well-known features have been omitted or simplified in order not to obscure the illustrative implementations.

Moreover, it should be understood that the illustrated embodiments are only examples, and should not be taken as limiting the scope of the present invention. For example, steps of disclosed methods may be taken in sequences other than those described, with more, fewer, or other processing steps. The disclosure should not be read as limited to the described order and/or number of steps and/or elements incorporated in the disclosed embodiments unless stated to that effect, A person of ordinary skill in the art can readily apply the principles of the present invention to produce more embodiments without deviating from its spirit and scope.

1. An apparatus comprising:
an optical circuit comprising a lightguide, the lightguide comprising a substantially isotropic halide material composition.

2. The apparatus of claim 1, wherein the halide material composition does not include grains larger than 0.5 um.

3. The apparatus of claim 1, wherein the halide material composition is a solidified molten silver halide material.

4. The apparatus of claim 1, wherein the halide material composition includes Silver (Ag) and at least one of Chlorine (Cl), Bromine (Br), and Iodine (I).

5. The apparatus of claim 4, wherein the halide material composition includes AgCl₍₁₋ₓ₎Brₓ, e.g., where x is between approximately 0.4-0.8.

6. The apparatus of claim 1, wherein the halide material composition includes dopants, the dopants including at least one of Cerium (Ce), Erbium (Er), Holmium (Ho), Dysprosium (Dy), Manganese (Mn), Iron (Fe), Chromium (Cr), Thulium (Tm), Ytterbium (Yb), or Neodymium (Nd).

7. The apparatus of claim 1, wherein the halide material composition has an optical transmission of greater than 60% for wavelengths between approximately 0.5 um and 25 um.

8. The apparatus of claim 1, wherein the lightguide is one of an optical fiber, a planar optical waveguide, and a nonlinear converter.

9. The apparatus of claim 1, further comprising at least one of a precipitated absorptive structure for polarization control and a Bragg grating.

10. A method of forming a lightguide, comprising:
passivating a surface of a glass retaining element;
depositing a molten halide material onto the passivated surface of the glass retaining element; and
cooling the glass retaining element and the molten halide material to solidify the halide material.

11. The method of claim 10, further comprising heating the halide material to a temperature between approximately 425° C.-550° C.

12. The method of claim 10, wherein passivating the surface of the glass retaining element comprises performing a silver ion exchange process.

13. The method of claim 12, wherein the silver ion exchange process comprises exposing the surface to a salt melt comprising silver nitrate.

14. The method of claim 12, wherein the silver ion exchange process is performed at a temperature between approximately 425° C.-550° C.

15. The method of claim 10, further comprising removing the glass retaining element by etching.

16. The method of claim 10, wherein the molten halide material is a silver halide.

17. The method of claim 16, wherein the molten halide material includes AgCl₍₁₋ₓ₎Brₓ, e.g., where x is between approximately 0.4-0.8.

18. The method of claim 16, wherein the molten halide material includes dopants, the dopants including at least one of Cerium (Ce), Erbium (Er), Holmium (Ho), Dysprosium (Dy), Manganese (Mn), Iron (Fe), Chromium (Cr), Thulium (Tm), Ytterbium (Yb), or Neodymium (Nd).

19. The method of claim 10, wherein the halide material is deposited onto the passivated surface via capillary action.

20. The method of claim 10, wherein the halide material is solidified in a microgravity environment.

21. A lightguide formed by a method comprising:
passivating surfaces of a glass retaining element;
depositing a molten halide material into the glass retaining element; and
cooling the molten halide material to solidify the halide material.

22. The lightguide of claim 21, wherein the lightguide has an optical transmission of greater than 60% for wavelengths between approximately 0.5 um and 25 um.

23. The lightguide of claim 21, wherein the molten halide material is a silver halide.

24. The lightguide of claim 23, wherein the molten halide material includes AgCl₍₁₋ₓ₎Brₓ, e.g., where x is between approximately 0.4-0.8.

25. The lightguide of claim 21, wherein the molten halide material includes dopants, the dopants including at least one of Cerium (Ce), Erbium (Er), Holmium (Ho), Dysprosium (Dy), Manganese (Mn), Iron (Fe), Chromium (Cr), Thulium (Tm), or Ytterbium (Yb).
